(19) United States
(12) Patent Application Publication
(10) Pub. No.: US 2026/0015893 A1
(43) Pub. Date: Jan. 15, 2026

(54) DOOR LOCK DEVICE

(71) Applicant: AISIN CORPORATION, Kariya (JP)

(72) Inventors: Koji Kumagai, Kariya-shi (JP); Yasuaki Tanino, Kariya-shi (JP); Yoshiki Odaka, Kariya-shi (JP); Yasuhiko Sono, Kariya-shi (JP); Akira Miyoshi, Kariya-shi (JP); Takumi Hayashi, Kariya-shi (JP)

(73) Assignee: AISIN CORPORATION, Kariya (JP)

(21) Appl. No.: 19/226,214

(22) Filed: Jun. 3, 2025

(30) Foreign Application Priority Data
Jul. 9, 2024 (JP) 2024-110275

(51) Int. Cl. E05B 77/16; E05B 77/34; E05B 79/20; E05B 85/04

(52) U.S. Cl. CPC E05B 77/16; E05B 77/34; E05B 79/20; E05B 85/045

(57) ABSTRACT

A closing member of a door lock device is connected to a tensile member and moves a latch to a full latch position when the latch is in a half latch position and the tensile member is pulled by a door closer. An ice breaker moves, when the ice breaker is in an actuated position where the ice breaker engages the closing member and the tensile member is pulled by the door closer, together with the closing member and presses the latch and moves the latch from the full latch position to the unlatch position. A cancel member holds, when in the retraction permitting position, the ice breaker in an unactuated position where rotation of the closing member is allowed, moves from the retraction permitting position to the retraction cancel position, and moves the ice breaker from the unactuated position to the actuated position.

### CROSS REFERENCE TO RELATED APPLICATIONS

This application is based on and claims priority under 35 U.S.C. § 119 to Japanese Patent Application 2024-110275, filed on Jul. 9, 2024, the entire content of which is incorporated herein by reference.

### TECHNICAL FIELD

This disclosure generally relates to a door lock device that is connected to a door closer via a tensile member and that holds a vehicle door in a closed state while allowing the door to be opened.

### BACKGROUND DISCUSSION

A door lock device including a latch mechanism including a latch and a pole and an ice breaking mechanism is known (see, for example, Chinese Utility Model No. 214786723). The ice breaking mechanism of the door lock device includes: a tension wheel connected to an actuator (a door closer) via a cable; an ice breaking swing arm rotatably supported by a bracket via a shaft and engageable with the tension wheel; an ice breaking tie rod connected to the ice breaking swing arm via a connecting shaft and engageable with the latch; and a reset spring that biases the ice breaking swing arm and the ice breaking tie rod in directions to separate from each other. When the cable is pulled by the actuator and the tension wheel rotates, the ice breaking swing arm and the ice breaking tie rod rotate in response to the rotation of the tension wheel, against the biasing force of the reset spring, and the ice breaking tie rod causes the latch to rotate in an unlatching direction. This allows ice to be broken in such a way that the door can be opened even when the door of the vehicle (a gap between an edge of the door and a vehicle body (weather trip)) in a fully closed position is frozen.

The ice breaking mechanism of the above-described conventional door lock device has a relatively complex structure including the ice breaking swing arm and the ice breaking tie rod that are connected via the connecting shaft. Therefore, the number of parts in the above-described door lock device increases, making it difficult to suppress cost increase. Whereas, according to the above-described door lock device, when freezing is not occurring at the door, the latch can be moved to a full latch position by the ice breaking swing arm and the ice breaking tie rod by pulling the cable with the actuator. However, in order to pull the cable and rotate the ice breaking swing arm and the ice breaking tie rod, it is necessary to cause the actuator to output force that overcomes the biasing force of the reset spring, which increases a load on the actuator.

A need thus exists for a door lock device, which is not susceptible to the drawback mentioned above.

### SUMMARY

A door lock device according to the present disclosure is connected to a door closer via a tensile member and holding a door of a vehicle in a closed state while allowing the door to be opened, and includes: a housing; a latch being rotatably supported by the housing and movable to a full latch position where the door is held in a fully closed position, a half latch position where the door is held in a half closed position and prevented from moving to an open position, and an unlatch position where the door is allowed to open; a pole being disposed in the housing and movable between a regulating position where the pole engages the latch and holds the latch in the full latch position and a non-regulating position where the latch is allowed to move from the full latch position to the unlatch position side; a closing member being rotatably supported by the housing and connected to the tensile member, and moving the latch, when the latch is in the half latch position and the tensile member is pulled by the door closer, from the half latch position to the full latch position; an ice breaker being movable between an unactuated position where the ice breaker is stationary relative to the housing and allows rotation of the closing member and an actuated position where the ice breaker engages the closing member, moving, when the ice breaker is in the actuated position and the tensile member is pulled by the door closer, together with the closing member, and pressing the latch in such a way as to move the latch from the full latch position to the unlatch position side; and a cancel member being movable between a retraction permitting position and a retraction cancel position, holding the ice breaker, when in the retraction permitting position, in the unactuated position, moving from the retraction permitting position to the retraction cancel position, and moving the ice breaker from the unactuated position to the actuated position.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic structure view of a door of a vehicle to which a door lock device of the present disclosure is applied;

FIG. 2 is a perspective view of the door lock device of the present disclosure;

FIG. 3 is a plan view of the door lock device of the present disclosure, viewed from the latch mechanism side;

FIG. 4 is a plan view of the door lock device of the present disclosure, viewed from the actuator side;

FIG. 5 is an enlarged view of the main part of the door lock device of the present disclosure;

FIG. 6 is an enlarged view of the main part for illustrating the operation of the door lock device of the present disclosure;

FIG. 7 is an enlarged view of the main part for illustrating the operation of the door lock device of the present disclosure;

FIG. 8 is an enlarged view of the main part for illustrating the operation of the door lock device of the present disclosure;

FIG. 9 is an enlarged view of the main part for illustrating the operation of the door lock device of the present disclosure;

FIG. 10 is an enlarged view of the main part for illustrating the operation of the door lock device of the present disclosure; and

FIG. 11 is an enlarged view of the main part for illustrating the operation of the door lock device of the present disclosure.

### DETAILED DESCRIPTION

Next, an embodiment for implementing the present disclosure will be described with reference to the drawings.

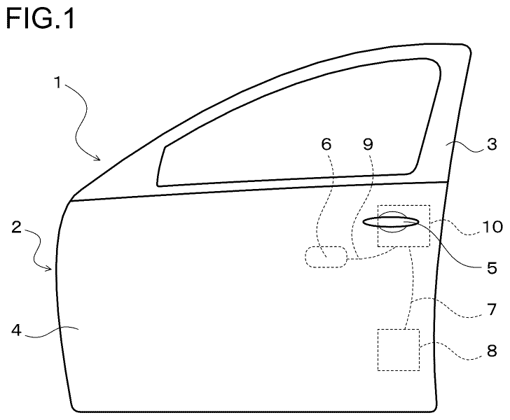

FIG. 1 is a schematic structure view of a door 1 of a vehicle to which a door lock device 10 of the present disclosure is applied. The door 1 is the front door of a driver or passenger seat of the vehicle, and includes: a door body 2 forming the lower half of the door 1; and a door sash 3 forming the upper half of the door 1 and guiding a window glass. The door body 2 includes, in addition to an outer panel 4, an inner panel (not illustrated) fixed to the inside (cabin side) of the outer panel 4 and a resin trim (not illustrated) fixed to the cabin side surface of the inner panel. The door 1 is a swing door rotatable from the fully closed position through the half closed position (half door position) to the fully open position using the front end rotatably supported by the vehicle body, not illustrated in FIG. 1, as a pivot point. The half closed position is the position moved slightly to the side of the open position from the fully closed position.

The door 1 also includes: an outside door handle 5 that is pullably or pivotably attached to the outer panel 4; and an inside door handle 6 that is pullably or pivotably attached to the trim. The outside door handle 5 and the inside door handle 6 are biased toward the initial position by a spring or other means not illustrated. A user of the vehicle can open the door 1 by operating (manual opening operation) the outside door handle 5 or inside door handle 6 to move it from the initial position to the door open position.

As illustrated in FIG. 1, the door lock device 10 is disposed in the interior space of the door 1 defined by the outer panel 4 and the inner panel that is not illustrated. More specifically, the door lock device 10 is fixed to, for example, the inner panel so that the door lock device 10 is located below the outside door handle 5 in the interior space. The door lock device 10 is then connected to a door closer 8, disposed in the interior space of the door 1, via a flexible cable 7. The door closer 8 includes an actuator (not illustrated) controlled by an electronic control unit (hereinafter referred to as “ECU”), not illustrated, which is configured to retract (pull) the cable 7 by the driving force of the actuator. The door lock device 10, the door closer 8, and the like are also equipped in doors other than the door 1 of the vehicle (the other front door and rear doors).

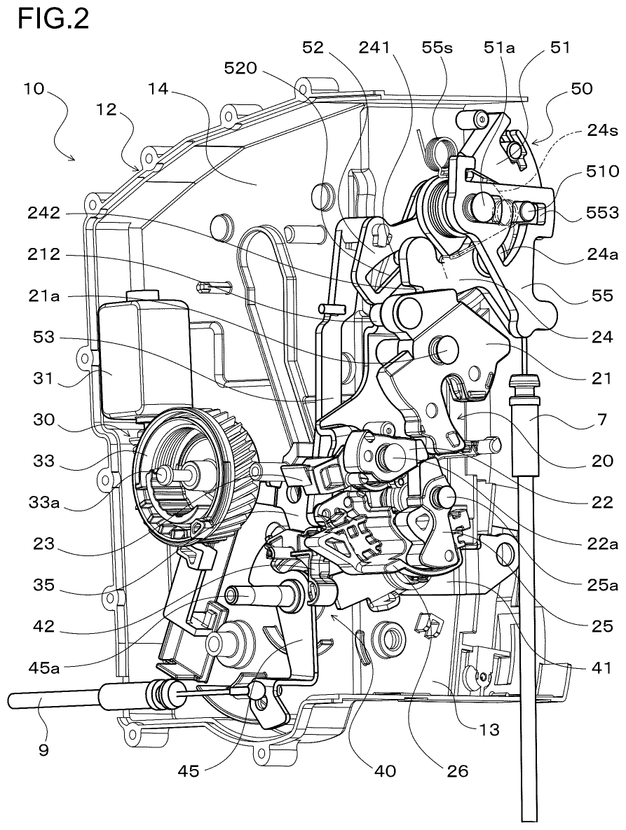

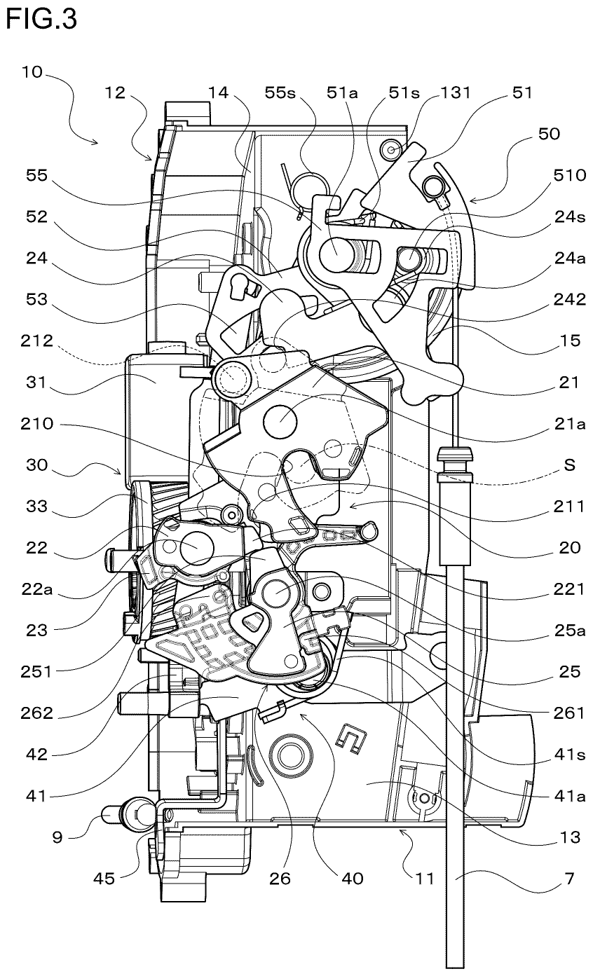

FIG. 2 is a perspective view of the door lock device 10, and FIG. 3 is a front view of the door lock device 10. As illustrated in these drawings, the door lock device 10 includes a latch housing 11, an actuator housing 12 connected perpendicularly to the latch housing 11, a latch mechanism 20 housed in the latch housing 11, an actuator 30 housed in the actuator housing 12, a manual operation mechanism 40, and a closing mechanism 50. The latch mechanism 20 is allowed to selectively form a full latch state where the door 1 is held in the fully closed position, a half latch state where the door 1 is held in the half closed position where the door 1 is slightly moved from the fully closed position to the open position, and an unlatch state where the door 1 is allowed to be opened.

As illustrated in FIGS. 2 and 3, the latch mechanism 20 includes a latch 21, a pole 22, a pole lift lever 23, a half pole (a half latch lever) 24, a block lever (a pole holding member) 25, and a block lift lever (a drive member) 26. The latch 21 is rotatable around a latch shaft 21a extending from a base part 13 forming the latch housing 11. The latch 21 is biased by a latch spring, not illustrated, around the latch shaft 21a relative to the latch housing 11 (clockwise direction in FIG. 3) in a direction to release a striker S that is fixed to the vehicle body. As illustrated in FIG. 3, the latch 21 includes a notch 210 that is engageable with the striker S, a full latch engagement part (a full latch engagement surface) 211, and a half latch engagement part (a half latch engagement pin) 212. The half latch engagement part 212 is formed on the far side of the latch body in FIG. 3 by a cylindrical member (pin) that is inserted in the body of the latch 21 and fixed so as to extend parallel to the latch shaft 21a.

The latch 21 can selectively move to a full latch position (refer to a solid line in FIG. 3), a half latch position (refer to a dash-dot-dot line in FIG. 3), and an unlatch position by rotating around the latch shaft 21a. In the full latch position, the striker S of the vehicle body is held by the notch 210 of the latch 21, thereby holding the door 1 in the fully closed position. The half latch position is a position rotated clockwise in FIG. 3 by a predetermined angle from the full latch position. In the half latch position, the door 1 is held in the half closed position with the striker S of the vehicle body held by the notch 210 of the latch 21. The unlatch position is a position rotated clockwise in FIG. 3 by a further predetermined angle from the half latch position. In the unlatch position, the striker S is released from the notch 210 of the latch 21 and the door 1 is allowed to open.

The pole 22 is rotatable around a shaft 22a extending from the base part 13 of the latch housing 11 parallel to the latch shaft 21a of the latch 21. The pole 22 includes an engagement part 221 as illustrated in FIG. 3. The pole lift lever 23 is connected to the pole 22 and is rotatable together with the pole 22 around the shaft 22a. The pole 22 and the pole lift lever 23 can selectively move between a regulating position illustrated in FIG. 3 and a non-regulating position (non-regulating range) by rotating together around the shaft 22a.

In this embodiment, the pole 22 and the pole lift lever 23 are biased counterclockwise in FIG. 3 around the shaft 22a relative to the latch housing 11 by a pole spring, not illustrated, so as to be in the regulating position. When the pole 22 and the pole lift lever 23 are in the regulating position, the engagement part 221 of the pole 22 is located inside (the upper side in FIG. 3) the rotational path of the full latch engagement part 211 of the latch 21. This allows the engagement part 221 of the pole 22 to engage the full latch engagement part 211 of the latch 21, and the pole 22 to hold the latch 21 in the full latch position.

The pole 22 and the pole lift lever 23 move to the non-regulating position by rotating together clockwise in FIG. 3 around the shaft 22a by a predetermined angle. When the pole 22 and the pole lift lever 23 have moved to the non-regulating position, the engagement part 221 of the pole 22 is located outside (the lower side in FIG. 3) of the rotational path of the full latch engagement part 211 of the latch 21. This allows the clockwise rotation in FIG. 3 of the latch 21 that is biased by the latch spring, that is, the latch is allowed to move to the unlatch position.

The half pole 24 is rotatable around the half pole shaft 24a extending parallel to the latch shaft 21a of the latch 21 and the like, and includes an engagement part 242 that is engageable with the half latch engagement part 212 of the latch 21 as illustrated in FIG. 3. By rotating around the half pole shaft 24a, the half pole 24 can selectively move between the engagement position illustrated in FIG. 3 and the disengagement position. Further, the half pole 24 is biased in a counterclockwise direction in FIG. 3 around the shaft 22a by the half pole spring 24s so as to be in the engagement position.

When the half pole 24 is in the engagement position, the engagement part 242 of the half pole 24 is located on the rotational path of the half latch engagement part 212 of the latch 21. This allows the engagement part 242 to engage the full latch engagement part 211 on the far side of the body of the latch 21 in FIG. 3 and the half pole 24 to hold the latch 21 in the half latch position. The half pole 24 moves to the disengagement position by rotating clockwise in FIG. 3 around the half pole shaft 24a by a predetermined angle against the biasing force of the half pole spring 24s. When the half pole 24 has moved to the disengagement position, the engagement part 242 of the half pole 24 is located outside (the upper side in FIG. 3) the rotational path of the full latch engagement part 211 of the latch 21. This allows the latch 21 that is biased by the latch spring to rotate clockwise in FIG. 3, that is, the latch 21 is allowed to move to the unlatch position.

The block lever 25 is rotatable around a shaft 25a extending from the base part 13 of the latch housing 11 parallel to the latch shaft 21a of the latch 21, and includes an engagement part 251 that is engageable with the engagement part 221 of the pole 22 as illustrated in FIG. 3. By rotating around the shaft 25a, the block lever 25 can selectively move between a holding position illustrated in FIG. 3 and a non-holding position. Further, the block lever 25 is biased counterclockwise in FIG. 3 around the shaft 25a by a block lever spring, not illustrated, so as to be located in the holding position.

When the block lever 25 is in the holding position, the engagement part 251 of the block lever 25 is located on the rotational path of the engagement part 221 of the pole 22. This allows the block lever 25 to restrict the pole 22 and the pole lift lever 23 from moving to the non-regulating position. The block lever 25 moves to the non-holding position by rotating clockwise in FIG. 3 around the shaft 25a by a predetermined angle. When the block lever 25 has moved to the non-holding position, the engagement part 251 of the block lever 25 is located outside (the right side in FIG. 3) the rotational path of the engagement part 221 of the pole 22. This allows the pole 22 and the pole lift lever 23 to rotate clockwise in FIG. 3, that is, to move to the non-regulating position.

The block lift lever 26, like the block lever 25, is rotatable around the shaft 25a extending from the base part 13 of the latch housing 11, and is disposed on the far side of the block lever 25 in FIG. 3. The block lift lever 26 can selectively move to a first position illustrated in FIG. 3, a second position, and a third position by rotating around the shaft 25a. The second position is a position rotated clockwise in FIG. 3 by a predetermined angle from the first position, and the third position is a position further rotated clockwise in FIG. 3 by a predetermined angle from the second position. Furthermore, the block lift lever 26 is biased counterclockwise in FIG. 3 around the shaft 25a by a block lift lever spring, not illustrated, so as to be located in the first position.

The block lift lever 26 includes a first engagement part 261 and a second engagement part 262. The first engagement part 261 protrudes toward the front side in FIG. 3 from the block lift lever 26 and is engageable with the block lever 25. When the block lift lever 26 moves from the first position to the second position or when the block lift lever 26 moves from the first position to the third position passing the second position, the first engagement part 261 contacts and presses the block lever 25 to move the block lever 25 from the holding position to the non-holding position against the biasing force of the block lever spring.

The second engagement part 262 is engageable with the pole lift lever 23. When the block lift lever 26 is in the first or second position, the second engagement part 262 does not engage (contact) the pole lift lever 23 and is separated from the pole lift lever 23. In contrast, while the block lift lever 26 moves from the second position to the third position, the second engagement part 262 moves upward in FIG. 3 and contacts and presses the pole lift lever 23 against the biasing force of the pole spring. At this time, the block lever 25 has already moved to the non-holding position, allowing the pole 22 to move from the regulating position to the non-regulating position. Therefore, when the block lift lever 26 moves from the second position to the third position, the pole 22 and the pole lift lever 23 move (rotate) together from the regulating position to the non-regulating position against the biasing force of the pole spring, allowing the latch 21 to rotate clockwise in FIG. 3, that is, to move to the unlatch position.

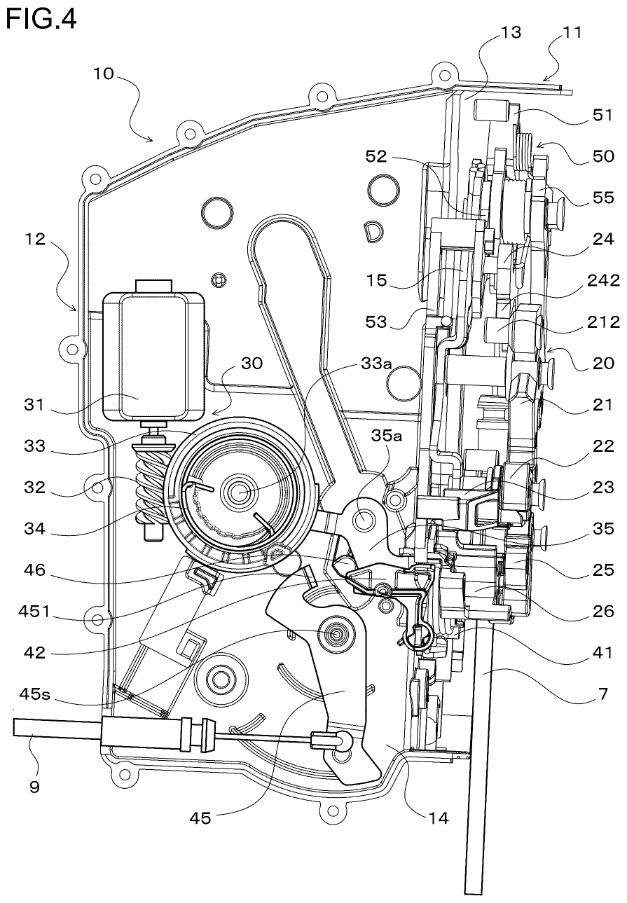

The block lift lever 26 described above is rotated around the shaft 25a by the actuator 30 disposed in the actuator housing 12. The actuator 30 as illustrated in FIG. 4 and other drawings includes a motor 31, a worm gear 32, a rotary member 33, a rotary biasing member 34, and a release lever 35. The motor 31 is controlled by the above-described ECU to provide rotary torque (driving force) in both forward and reverse directions. The rotary member 33 is a worm wheel that can rotate in both forward and reverse directions around a shaft 33a extending from the base part 14 forming the actuator housing 12 and is meshed with the worm gear 32 attached to the rotary shaft of the motor 31.

In this embodiment, the worm gear 32 of the motor 31 and the rotary member 33 can be driven in opposite directions. The rotary member 33 is driven in the forward and reverse directions by the rotary torque exerted from the motor 31 and can selectively move between a neutral position and a release position. The rotary biasing member 34 is a torsion coil spring that biases the rotary member 33 around the shaft 33a toward a predetermined neutral position when the motor 31 has stopped rotating. Furthermore, the rotary member 33 has an engagement part (not illustrated) that is engageable with the release lever 35, and the engagement part moves downward in FIGS. 2 to 4 when the rotary member 33 moves from the neutral position to the release position.

The release lever 35 is a relatively long plate with a through hole formed in the center of the release lever 35 in the longitudinal direction through which a shaft 35a that extends parallel to the shaft 33a from the base part 14 of the actuator housing 12 is inserted. In other words, the release lever 35 is rotatably supported by the actuator housing 12 around the shaft 35a, and can selectively move between a neutral position and a release position by rotating around the shaft 35a. The release lever 35 includes a first engagement part that is engageable with the engagement part of the rotary member 33 at one end in the longitudinal direction and a second engagement part that is engageable with the above-described block lift lever 26 at the other end in the longitudinal direction. The first engagement part of the release lever 35 is located below the engagement part of the rotary member 33 in FIG. 3 and other drawings, and the second engagement part of the release lever 35 is located below the engagement part, not illustrated, formed on the block lift lever 26 in FIG. 3 and other drawings.

When the rotary member 33 moves (rotates) from the neutral position to the release position due to the rotary torque from the motor 31, the first engagement part is pushed down by the engagement part of the rotary member 33 and the release lever 35 moves from the neutral position to the release position while the second engagement part rises. This causes the second engagement part of the release lever 35 to push up the engagement part, not illustrated, of the block lift lever 26, and the block lift lever 26 moves from the first position to the third position passing the second position against the biasing force of the block lift lever spring. As a result, the latch mechanism 20 can be switched from the full latch state to the half latch or unlatch state by actuating the actuator 30.

On the other hand, if the motor 31 stops rotating after the latch mechanism 20 becomes the unlatch state, the rotary member 33 moves (rotates) from the release position to the neutral position by the biasing force of the rotary biasing member 34. As a result, the block lift lever 26 is no longer pressed by the second engagement part of the release lever 35, and the block lift lever 26 moves (returns) to the first position by the biasing force of the block lift lever spring. Furthermore, the release lever 35 is pressed by the block lift lever 26 and moves (returns) to the neutral position.

In the door lock device 10, the latch mechanism 20 can be switched from the full latch or half latch state to the unlatch state in response to the manual opening operation of the outside door handle 5 or inside door handle 6 by a user. In other words, the door lock device 10 includes, as the manual operation mechanism 40, an outside open lever 41 linked to the outside door handle 5 and an inside open lever 45 linked to the inside door handle 6 as illustrated in FIGS. 2 to 4.

The outside open lever 41 is a relatively long plate with a through hole formed in the center of the outside open lever 41 in the longitudinal direction through which a shaft 41a extending parallel to the latch shaft 21a and the like from the base part 13 of the latch housing 11 is inserted. In other words, the outside open lever 41 is rotatably supported by the latch housing 11 around the shaft 41a, and by rotating around the shaft 41a, the outside open lever 41 can selectively move between an unactuated position illustrated in FIG. 3 and an actuated position.

The outside open lever 41 is biased counterclockwise in FIG. 3, by an open lever spring 41s, around the shaft 41a relative to the latch housing 11 so as to be located in the unactuated position. One end of the outside open lever 41 (the right end in FIG. 3) engages an open rod, not illustrated, that is linked to the outside door handle 5. Furthermore, a connection part is formed at the other end of the outside open lever 41 (the left end in FIG. 3), and the connection part is connected to an open link 42 so that the open link 42 can rotate freely with respect to the outside open lever 41. The open link 42 can approach and retract from the block lift lever 26 in conjunction with the outside open lever 41 that rotates around the shaft 41a.

When the outside door handle 5 is manually opened by a user, the above-described open rod moves downward in FIG. 3. Accordingly, the outside open lever 41 rotates clockwise in FIG. 3 around the shaft 41a against the biasing force of the open lever spring 41s and moves from the unactuated position to the actuated position. As a result, the open link 42 connected to the outside open lever 41 contacts a part of the block lift lever 26 and pushes up the block lift lever 26, causing the block lift lever 26 to move from the first position to the third position passing the second position. As a result, the latch mechanism 20 can be switched from the full latch or half latch state to the unlatch state by the manual opening operation of the outside door handle 5.

The inside open lever 45 is rotatably supported by the shaft 45a extending parallel to the shaft 33a and the like from the base part 14 of the actuator housing 12, as illustrated in FIG. 4, and by rotating around the shaft 45a, the inside open lever 45 can selectively move between an unactuated position illustrated in FIG. 4 and an actuated position. The inside open lever 45 is biased counterclockwise in FIG. 4 around the shaft 45a relative to the actuator housing 12 by an open lever spring, not illustrated, so as to be located in the unactuated position. One end (the lower end in FIG. 4) of the inside open lever 45 is connected to a cable 9 that is linked to the inside door handle 6. Furthermore, the other end of the inside open lever 45 (the upper end in FIG. 4) forms a pressure part 451 that can press the release lever 35 to move it from the neutral position to the release position via a bushing 46 that is rotatably supported together with the release lever 35 by the shaft 35a.

When the inside door handle 6 is manually opened by a user, the cable 9 is pulled to the left side in FIG. 4 by the inside door handle 6. Accordingly, the inside open lever 45 rotates clockwise in FIG. 4 around the shaft 45a against the biasing force of the open lever spring, not illustrated, and moves from the unactuated position to the actuated position. Further, the pressure part 451 of the inside open lever 45 presses the release lever 35 to move it from the neutral position to the release position via the bushing 46. This causes the second engagement part of the release lever 35 to push up the engagement part, not illustrated, of the block lift lever 26 and the block lift lever 26 moves from the first position to the third position passing the second position against the biasing force of the block lift lever spring. As a result, the latch mechanism 20 can be switched from the full latch or half latch state to the unlatch state by the manual opening operation of the inside door handle 6.

After the latch 21 has moved to the unlatch position, when the user of the vehicle returns the outside door handle 5 or inside door handle 6 back to the initial position, the outside open lever 41 returns to the unactuated position, biased counterclockwise in FIG. 3 around the shaft 41a by the open lever spring 41s. The open link 42 is separated from the block lift lever 26 in conjunction with the rotation of the outside open lever 41 to release the pressure on the block lift lever 26. Furthermore, the block lift lever 26 moves (returns) to the first position by the biasing force of the block lift lever spring, and the block lever 25 moves (returns) to the holding position.

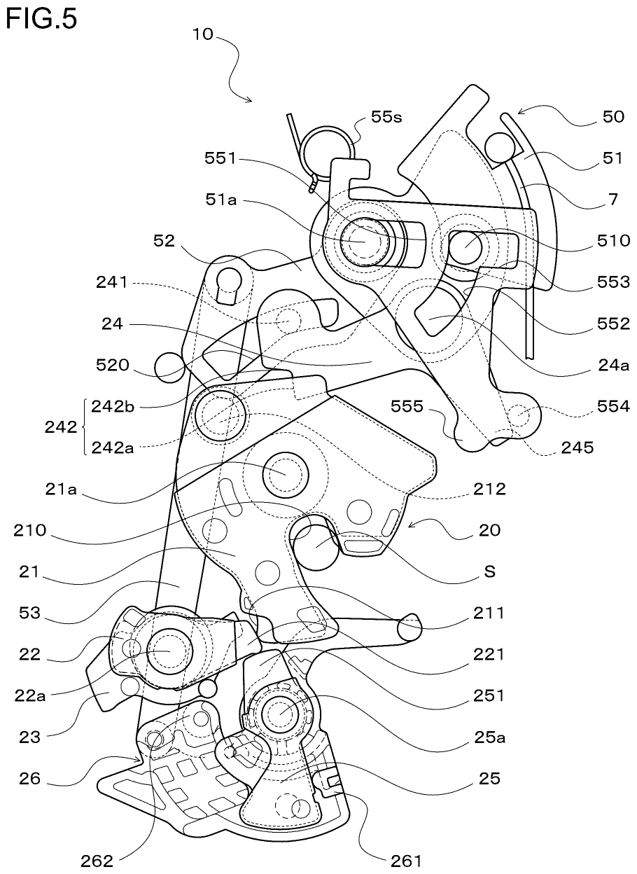

The closing mechanism 50 can switch the latch mechanism 20 from the half latch state to the full latch state and retracting the door 1 by the driving force of the door closer 8 when the door 1 is in the half closed position and the latch mechanism 20 is in the half latch state (so-called “half door” state). The closing mechanism 50 includes a closing member 51 and a cancel lever (a cancel member) 52. The closing member 51 is rotatable around a shaft (support shaft) 51a extending from the base part 13 of the latch housing 11 parallel to the latch shaft 21a and the like of the latch 21. The closing member 51 is biased toward the initial position illustrated in FIGS. 3 and 5 by a spring 51s and, at the initial position, contacts a stopper 131 provided on the base part 13 of the latch housing 11.

As illustrated in FIGS. 3 and 5, the closing member 51 is connected to one end of the cable 7. When the cable 7 is pulled by the door closer 8, the closing member 51 rotates clockwise in the drawings around the shaft 51a from the initial position and moves to a closed position. In this embodiment, the closing member 51 includes a cylindrical guided part 510 extending parallel to the shaft 5la and protruding from the front and back surfaces of the closing member 51. The far end of the guided part 510 in FIGS. 3 and 5 is slidably guided by a guide groove, not illustrated, formed in a sub-base 15 that is fixed to the base part 13 of the latch housing 11. When the closing member 51 reaches the closed position, the guided part 510 contacts a part (a stopper part) that defines one end the guide groove of the sub-base 15.

Furthermore, as illustrated in FIGS. 3 and 5, the closing member 51 supports the half pole shaft 24a described above and rotatably supports the half pole 24 of via the half pole shaft 24a. In this embodiment, the half pole 24 is formed in an abbreviated L-shape and is rotatably supported by the closing member 51 via the half pole shaft 24a that is inserted through the bent part of the half pole 24. The half pole 24 is disposed on the front side of the closing member 51 in FIGS. 3 and 5, and when the closing member 51 is in the initial position, the half pole 24 is located in the above-described engagement position, biased by the half pole spring 24s one end of which is supported by the closing member 51. Furthermore, the engagement part 242 of the half pole 24 is formed on one end side of the half pole 24 and has two contact surfaces 242a and 242b that can each contact the outer circumference of the half latch engagement part 212 of the latch 21 on the latch shaft 21a side (the lower side) than the half pole shaft 24a as illustrated in FIG. 5. One contact surface 242a is formed to contact the half latch engagement part 212 having a circular cross-sectional shape from the half pole shaft 24a side (laterally), and the other contact surface 242b is formed to contact the half latch engagement part 212 from the opposite side (the upper side) of the latch shaft 21a side.

The cancel lever 52, like the closing member 51, is rotatable around the shaft 5la extending from the base part 13 of the latch housing 11, and is biased toward the retraction permitting position illustrated in FIGS. 3 and 5 by a cancel lever spring that is not illustrated. In this embodiment, the cancel lever 52 is disposed on the far side of the closing member 51 in FIGS. 3 and 5. The cancel lever 52 has a guide part 520 as illustrated in FIG. 5. The guide part 520 is an opening extending in an abbreviated arc form, and the guide part 520 slidably guides a cylindrical guided part 241 formed at one end of the half pole 24. In this embodiment, the guided part 241 protrudes from one end of the half pole 24 toward the far side in FIGS. 3 and 5, and is loosely fitted within the guide part 520. Furthermore, the cancel lever 52 is connected to the block lift lever 26 via a relatively long connection member (connection rod) 53.

When the block lift lever 26 is in the above-described first position, the cancel lever 52, is held in the retraction permitting position illustrated in FIGS. 3 and 5. When the cancel lever 52 is in the retraction permitting position, the half pole 24 is held in the above-described engagement position by the biasing force of the half pole spring 24s. When the block lift lever 26 moves from the first position to the third position by either rotary torque (driving force) of the actuator 30 (the motor 31) or manual opening operation by a user, the cancel lever 52, moving in conjunction with the block lift lever 26 via the connection member 53, rotates clockwise in FIGS. 3 and 5 around the shaft 5la by a predetermined angle and moves to the retraction cancel position. Furthermore, while the cancel lever 52 moves from the retraction permitting position to the retraction cancel position, the inner surface of the guide part 520 presses the guided part 241 of the half pole 24, causing the half pole 24 to rotate clockwise in FIGS. 3 and 5 relative to the closing member 51. In this way, when the block lift lever 26 moves from the first position to the third position, the half pole 24 moves from the engagement position to the disengagement position against the biasing force of the half pole spring 24s before the pole 22 and pole lift lever 23 move (rotate) from the regulating position to the non-regulating position against the biasing force of the pole spring.

The closing mechanism 50 of the door lock device 10 also includes an ice breaker 55 that provides an ice breaking function, and when the door 1 in the fully closed position (the gap between the edge of the door 1 and the vehicle body (weather trip)) is frozen, the ice breaker 55 can be pressed against the latch 21 to allow the door 1 to open. The ice breaker 55 is a plate having an abbreviated triangular planar shape and includes a first hole 551, a second hole 552, and a third hole 553. The first hole 551 is a long hole extending in a predetermined direction penetrating through the ice breaker 55. In the first hole 551, a shaft (a support shaft) 5la extending from the base part 13 of the latch housing 11 is inserted so that the shaft 51a can move freely between one end (the left end in FIG. 5) and the other end (the right end in FIG. 5). In other words, the ice breaker 55 is slidably supported in the predetermined direction (in the direction of extension of the first hole 551) by the shaft 51a that is commonly used by the closing member 51 and the cancel lever 52.

The second hole 552 is an arc-shaped hole extending along an arc centered on the shaft 51a located at one end of the first hole 551 (the left end in FIG. 5). When the shaft 5la is located at one end of the first hole 551, an end of the guided part 51 of the closing member 510 on the front side in FIG. 5 is slidably inserted in the second hole 552. As a result, when the shaft 5 la is located at the one end of the first hole 551, the guided part 510 is slidably guided by the second hole 552 and rotation of the closing member 51 around the shaft 5la is allowed. The third hole 553 is extended from one end of the second hole 552 (the upper end in FIG. 5) so as to be separated from the first hole 551 along the above-described predetermined direction, that is, the direction of extension of the first hole 551. As the shaft 5la moves from the one end of the first hole 551 to the other end (the right end in FIG. 5), the guided part 510 of the closing member 51 enters into the third hole 553 and engages the third hole 553 (the ice breaker 55).

Furthermore, the ice breaker 55 is biased in a direction from the third hole 553 toward the first hole 551 (leftward in FIG. 5) by a spring (a biasing member) 55s supported by the latch housing 11. In addition, the ice breaker 55 includes: an engagement part 554 that is engageable with the other end 245 of the half pole 24; and a pressing part 555 that can contact the latch 21. The half pole 24, when in the above-described engagement position, engages the engagement part 554 to restrict movement of the ice breaker 55 in a direction from the third hole 553 to the first hole 551, and holds the ice breaker 55 in an unactuated position illustrated in FIG. 5 against the biasing force of the spring 55s. In the unactuated position, the ice breaker 55 is stationary relative to the latch housing 11, the shaft 5la is located at the one end of the first hole 551 (the left end in FIG. 5), and the guided part 510 of the closing member 51 is located at the one end of the second hole 552 (the top end in FIG. 5).

The half pole 24 rotates clockwise in FIG. 5 relative to the closing member 51 as the cancel lever 52 moves from the retraction permitting position to the retraction cancel position. As a result, the half pole 24 moves from the engagement position to the disengagement position, allowing the ice breaker 55 to move in a direction from the third hole 553 to the first hole 551 by the biasing force of the spring 55s. The ice breaker 55 then moves to the actuated position by the biasing force of the spring 55s. In the ice breaker 55 at the actuated position, the shaft 5 la is located at the other end (the right end in FIG. 5) of the first hole 551 and the guided part 510 of the closing member 51 enters into the third hole 553.

The operation of the latch mechanism 20 and closing mechanism 50 is below described with reference to FIGS. 5 to 9.

As illustrated in FIG. 5, when the door 1 is in the fully closed position and the latch 21 is held in the full latch position, if the outside door handle 5 or the inside door handle 6 is manually opened by a user of the vehicle, the block lift lever 26 moves from the first position through the second position to the third position against the biasing force of the block lift lever spring. Accordingly, the first engagement part 261 of the block lift lever 26 presses the block lever 25 to move (rotate) it from the holding position to the non-holding position, and then the second engagement part 262 moves (rotates) the pole 22 and pole lift lever 23 from the regulating position to the non-regulating position against the biasing force of the pole spring. In response to the movement of the block lift lever 26 from the first position to the third position, the cancel lever 52 rotates around the shaft 51a and moves from the retraction permitting position to the retraction cancel position. Accordingly, the half pole 24 moves from the engagement position to the disengagement position before the pole 22 moves to the non-regulating position.

As a result, in response to the movement of the pole 22 to the non-regulating position, the latch 21 moves (rotates) from the full latch position to the unlatch position side by the biasing force of the latch spring so that the door 1 can be rotated to the fully open position by manual opening operation of the outside door handle 5 or the like. However, depending on the degree of operation of the outside door handle 5 or the like, the block lift lever 26 quickly moves (returns) to the first position by the biasing force of the block lift lever spring in response to the return of the outside door handle 5 or the like. Accordingly, the cancel lever 52 moves (returns) to the retraction permitting position and the half pole 24 moves (returns) to the engagement position, respectively. Thus, when the outside door handle 5 or the like is lightly operated, the half latch engagement part 212 of the latch 21, biased by the half pole spring 24s, contacts (engages) the contact surfaces 242a, 242b of the engagement part 242 of the half pole 24 in the engagement position.

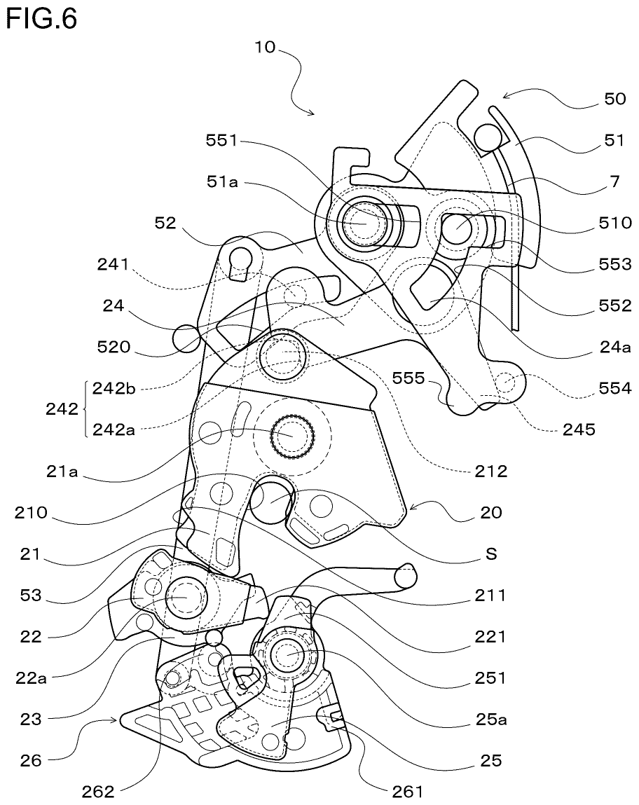

As a result, the latch mechanism 20 forms a half latch state where the door 1 is held in the half closed position and the movement of the latch 21, biased by the latch spring, to the unlatch position is restricted as illustrated in FIG. 6. In such a half latch state, since the half pole 24 is in the engagement position and the cancel lever 52 is in the retraction permitting position, the ice breaker 55 is held in the unactuated position by the half pole 24 against the biasing force of the spring 55s and becomes stationary relative to the latch housing 11. Furthermore, in the half latch state, the engagement part 251 engages the engagement part 221 of the pole 22 in the non-regulating position so that the block lever 25 is held in the non-holding position.

On the other hand, when the door 1 is open and the latch 21 is in the unlatch position by the biasing force of the latch spring, if the door 1 is rotated toward the fully closed position side by a user of the vehicle, the latch 21 is pressed by the striker S of the vehicle body that has entered in the notch 210 and moves (rotates) toward the half latch position against the biasing force of the latch spring. The half latch engagement part 212 of the latch 21, when moving toward the half latch position, presses and rotates the half pole 24 clockwise in FIG. 5 and other drawings around the half pole shaft 24a. As a result, the half pole 24 moves from the engagement position to the disengagement position, which in turn presses the cancel lever 52 and causes it to rotate clockwise in FIG. 5 and other drawings around the shaft 51a from the retraction permitting position. The cancel lever 52 also rotates clockwise in FIG. 5 and other drawings around the shaft 51a to pull (pull up) the connection member 53.

In response to the movement of the connection member 53, the block lift lever 26 moves from the first position to at least the second position against the biasing force of the block lift lever spring, and the first engagement part 261 of the block lift lever 26 presses the block lever 25 to move it from the holding position to the non-holding position. Furthermore, the latch 21, moving (rotating) toward the half latch position, presses the pole 22, causing the pole 22 and pole lift lever 23 to move (rotate) from the regulating position to the non-regulating position against the biasing force of the pole spring. If the force applied to the door 1 toward the closing side is small, when the latch 21 reaches the half latch position, the half latch engagement part 212 contacts (engages) the contact surfaces 242a, 242b of the engagement part 242 of the half pole 24 that has moved (returned) to the engagement position by the biasing force of the half pole spring 24s. The latch mechanism 20 thus forms the half latch state illustrated in FIG. 6.

When the half pole 24 moves (returns) to the engagement position by the biasing force of the half pole spring 24s, the cancel lever 52 rotates counterclockwise in FIG. 5 and other drawings around the shaft 51a and moves (returns) to the retraction permitting position while moving (pushing down) the connection member 53 toward the block lift lever 26 side. As a result, the block lift lever 26 moves (returns) to the first position by the biasing force of the block lift lever spring. On the other hand, the block lever 25 is held in the non-holding position by the engagement part 251 engaging the engagement part 221 of the pole 22 in the non-regulating position. Furthermore, the ice breaker 55 is held in the unactuated position by the half pole 24 against the biasing force of the spring 55s and becomes stationary relative to the latch housing 11.

Herein, the latch mechanism 20, after forming the half latch state as described above, shifts to the full latch or unlatch state in response to manual opening operation, switch operation, or the like by a user. However, in cases such as when proper operation is not performed by a user, the latch mechanism 20 may remain in the half latch state in any of the plurality of doors of the vehicle including the door 1. For this reason, the ECU controlling the door lock device 10 and door closer 8 of each door monitors the status of a plurality of sensors (switches), not illustrated, that are provided for each of the plurality of doors and detect formation of the half latch state to determine whether the half latch state continues for a predetermined duration or longer in any of the plurality of doors. Then, if the half latch state continues for the predetermined duration or longer in any of the plurality of doors, the ECU activates the actuator of the corresponding door closer 8 so as to switch the latch mechanism 20 of the door in question from the half latch state to the full latch state.

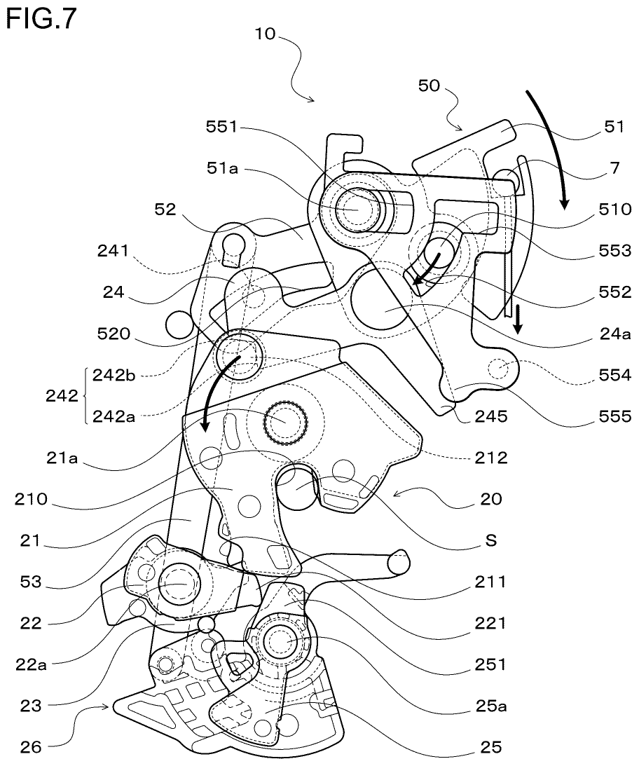

If the above-described door 1 continues to be in the half latch state for more than the predetermined duration, the ECU activates the actuator of the door closer 8 of the door 1 so that the actuator retracts the cable 7. As described above, in the half latch state, the ice breaker 55 is held in the unactuated position by the half-pole 24 against the biasing force of the spring 55s, the shaft 5la of the closing member 51 is located at one end of the first hole 551 (the left end in FIG. 6), and the guided part 510 of the closing member 51 is located at one end of the second hole 552. Therefore, when the cable 7 is pulled by the door closer 8, the closing member 51 moves from the initial position to the closed position by rotating clockwise in FIG. 7 around the shaft 5la, as illustrated in FIG. 7, and the guided part 510 of the closing member 51 moves while being guided by the second hole 552.

When the closing member 51 rotates toward the closed position, the half pole 24, as illustrated in FIG. 7, rotates around the half-pole shaft 24a relative to the closing member 51, as well as, moves together with the closing member 51 while being slidably guided (supported) by the cancel lever 52 in the retraction permitting position via the guided part 241 and the guide part 520 to press the half latch engagement part 212 of the latch 21. As a result, the latch 21 rotates counterclockwise in FIG. 7 around the latch shaft 21a and moves from the half latch position toward the full latch position. Accordingly, the striker S of the vehicle body that has entered the notch 210 is pressed toward the outside of the vehicle as the latch 21 rotates, and the reaction force moves the door 1 from the half closed position to the fully closed position.

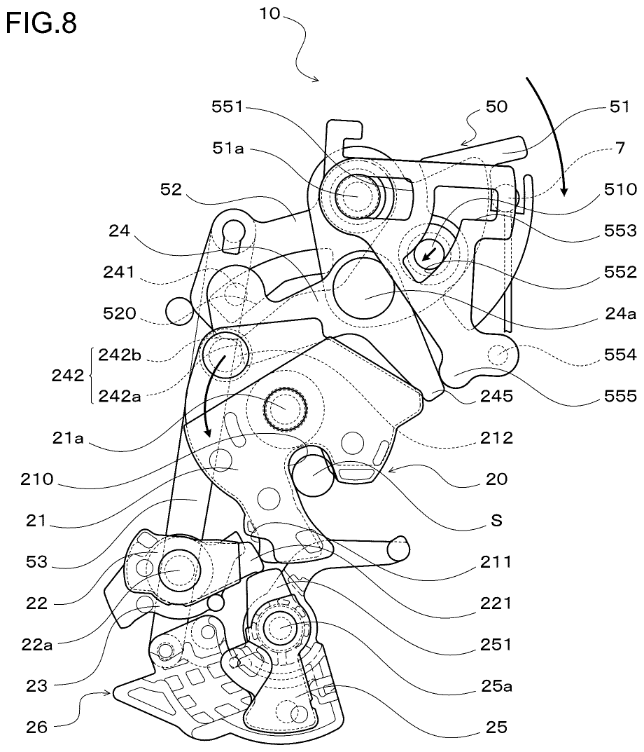

While the latch 21 moves (rotates) toward the full latch position, the pressure on the pole 22 applied by the latch 21 is released, and the pole 22 and the pole lift lever 23 move (rotate) from the non-regulating position to the regulating position by the biasing force of the pole spring. Furthermore, in response to the movement of the pole 22 and the pole lift lever 23 to the regulating position, the block lever 25 moves (rotates) from the non-holding position to the holding position by the biasing force of the block lever spring and restricts the pole 22 and pole lift lever 23 from moving to the non-regulating position. As a result, when the closing member 51 reaches the closed position, the latch 21 is located in the full latch position and the latch mechanism 20 forms the full latch state, as illustrated in FIG. 8, and the door 1 retracted into the vehicle body is held in the fully closed position.

Furthermore, when the formation of the full latch state is detected by a sensor (switch), not illustrated, equipped in the door 1, the above-described ECU controls the door closer 8 to release the retraction of the cable 7. As a result, the closing member 51 moves (rotates) to the initial position while pulling the cable 7 and the half pole 24 by the biasing force of the spring 51s. When the closing member 51 has moved to the initial position, the half pole 24 is located in the above-described engagement position, biased by the half pole spring 24s. While the closing member 51 rotates around the shaft 51a as described above, the cancel lever 52 is held in the retraction permitting position, thereby holding the ice breaker 55 in the unactuated position.

On the other hand, when a cancellation switch, not illustrated, is operated by the user of the vehicle after the retraction of the cable 7 by the door closer 8 has started, the ECU controls the door closer 8 to release the retraction of the cable 7 and also controls the motor 31 to cause the rotary member 33 of the actuator 30 to move (rotate) from the neutral position to the release position. Alternatively, when the outside door handle 5 or inside door handle 6 is manually opened by the user of the vehicle after the retraction of the cable 7 by the door closer 8 has started, the above-described ECU controls the door closer 8 to release the retraction of the cable 7. As a result, in response to the release of the retraction of the cable 7, the closing member 51 moves (rotates) to the initial position by the biasing force of the spring 51s while pulling the cable 7 and the half pole 24. Furthermore, the block lift lever 26 moves from the first position to the third position passing the second position by either the rotary torque (driving force) of the actuator 30 (the motor 31) or manual opening operation by the user.

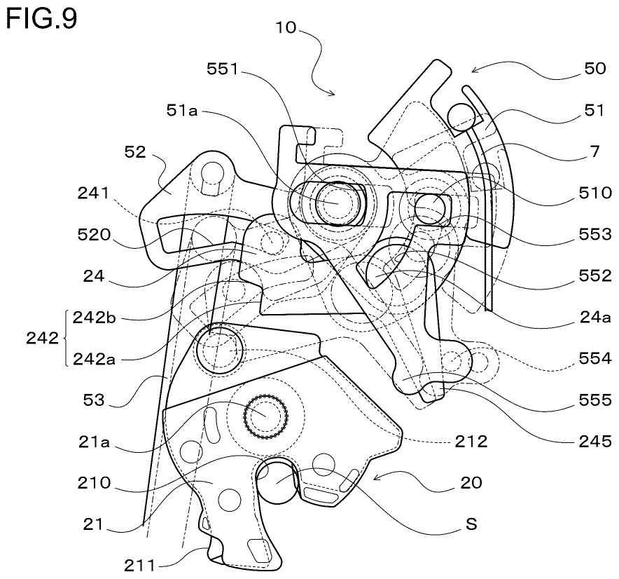

The cancel lever 52 also rotates clockwise in FIG. 9 around the shaft 51a in conjunction with the block lift lever 26 via the connection member 53 and moves from the retraction permitting position (refer to a dash-dot-dot line in FIG. 9) to the retraction cancel position, as illustrated in FIG. 9. Furthermore, while moving from the retraction permitting position to the retraction cancel position, the cancel lever 52 presses the guided part 241 of the half pole 24 by the inner surface of the guide part 520, and rotates the half pole 24 relative to the closing member 51 in a clockwise direction in FIG. 9 against the biasing force of the half pole spring 24s. This moves the half pole 24 from the engagement position to the disengagement position so that the engagement part 242 (the contact surfaces 242a, 242b) of the half pole 24 is disengaged from the half latch engagement part 212 of the latch 21. As a result, the latch 21 is allowed to move (rotate) to the unlatch position side, cancelling the movement of the latch 21 to the full latch position (retraction of the door 1) in response to the retraction of the cable 7.

As the half pole 24 moves from the engagement position to the disengagement position in response to the movement of the cancel lever 52, the ice breaker 55 moves to the actuated position once by the biasing force of the spring 55s, as illustrated in FIG. 9. When the block lift lever 26 moves (returns) to the first position by the biasing force of the block lift lever spring in response to the return of the outside door handle 5 and the like or the stop of the motor 31, the cancel lever 52 moves to the retraction permitting position, the half pole 24 moves to the engagement position, and the ice breaker 55 moves (returns) to the unactuated position, respectively.

Continuing with reference to FIGS. 5, 10, and 11, the ice breaking function of the door lock device 10 is described.

When the door 1 (the gap between the edge of the door 1 and the vehicle body (weather trip)) is frozen in the fully closed position with the latch mechanism 20 forming the full latch state as illustrated in FIG. 5, the door 1 may not be opened by manual opening operation or the like of the outside door handle 5. In light of this, the door lock device 10 is configured to provide an ice breaking function in response to operation of a predetermined switch on a remote control key or execution of an application installed on a portable terminal such as a smart phone. In other words, in response to a request from the remote control key or the like to perform the ice breaking function, the ECU controlling the door lock device 10 and the door closer 8 controls the motor 31 to cause the rotary member 33 of the actuator 30 to move (rotate) from the neutral position to the release position and to hold the rotary member 33 in the release position.

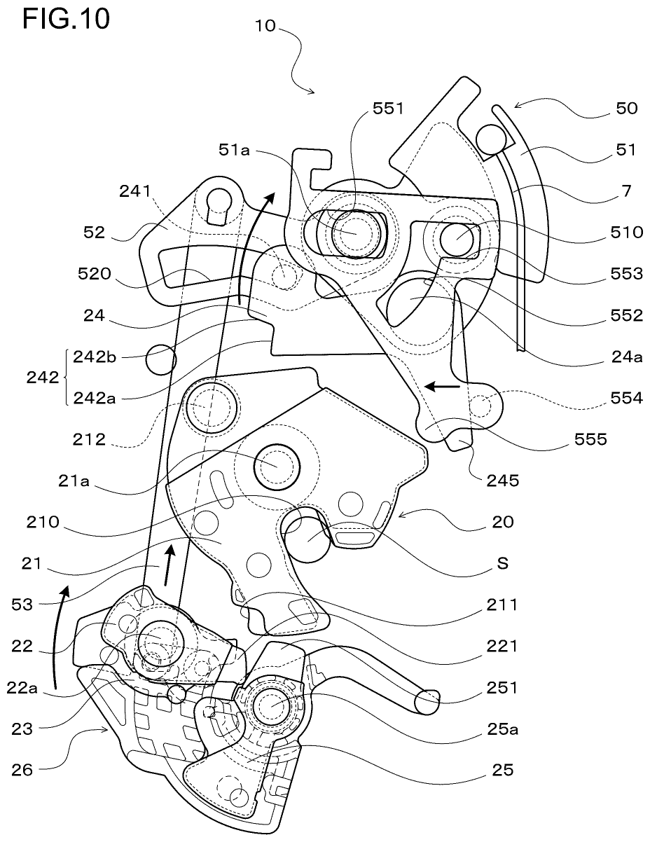

As a result, the rotary torque (driving force) of the actuator 30 (the motor 31) moves the block lift lever 26 from the first position to the third position passing the second position, and, as illustrated in FIG. 10, moves the cancel lever 52 in conjunction with the block lift lever 26 via the connection member 53 from the retraction permitting position to the retraction cancel position. Furthermore, while moving from the retraction permitting position to the retraction cancel position, the cancel lever 52 moves the half pole 24 from the engagement position to the disengagement position, and, as the half pole 24 moves from the engagement position to the disengagement position, the ice breaker 55 moves to the actuated position by the biasing force of the spring 55s.

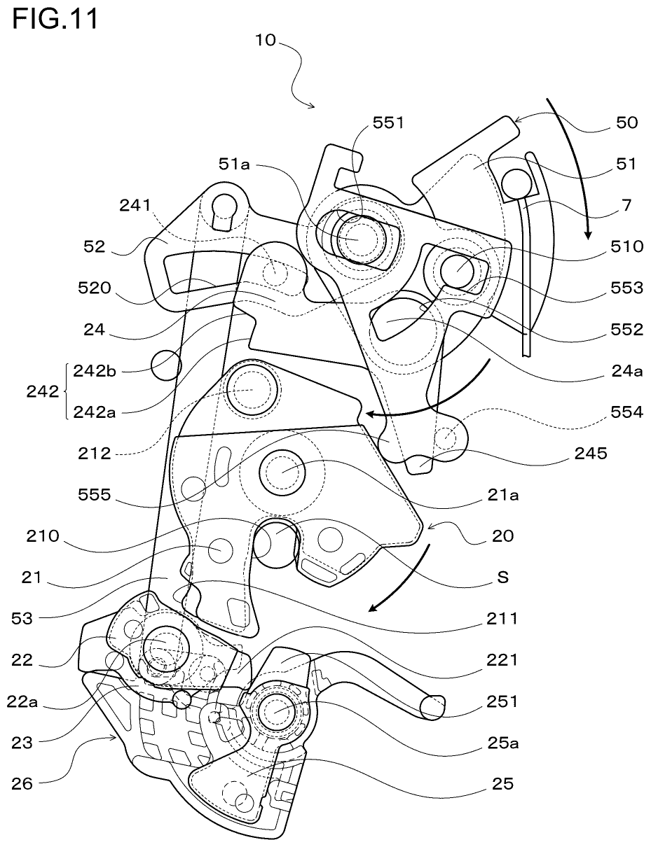

When the ice breaker 55 is held in the actuated position, the ECU activates the actuator of the door closer 8 of the door 1 to retract the cable 7. When the ice breaker 55 is in the actuated position, the shaft 51a is located at the other end of the first hole 551 (the right end in FIG. 10), the guided part 510 of the closing member 51 enters the third hole 553, and the ice breaker 55 engages the closing member 51. Therefore, when the cable 7 is retracted by the door closer 8, the closing member 51 rotates clockwise in FIG. 11 around the shaft 5la and moves from the initial position toward the closed position, as illustrated in FIG. 11, and the ice breaker 55 rotates clockwise in FIG. 11 around the shaft 5la together with the closing member 51.

This allows the pressing part 555 of the ice breaker 55 to press the latch 21 so that the latch 21 rotates around the latch shaft 21a in a direction toward the unlatch position (the clockwise direction in FIG. 11). As a result, the force applied to the latch 21 from the ice breaker 55 can break the ice so that the door 1 can be opened. In the door lock device 10, the ECU controls the door closer 8 and the like so that the latch 21 is pressed a plurality of times by the ice breaker 55, if necessary, depending on the position of the latch 21 and other conditions after the door closer 8 is activated. When the door 1 is allowed to be opened by moving (rotating) the latch 21 to the unlatch position side, the ECU controls the door closer 8 to release the retraction of the cable 7, as well as, controls the motor 31 to stop the output of rotary torque. As a result, the closing member 51 moves (rotates) to the initial position by the biasing force of the spring 51s while pulling the cable 7 and the half pole 24, the block lift lever 26 moves (returns) to the first position by the biasing force of the block lift lever spring, the cancel lever 52 moves (returns) to the retraction permitting position; the half pole 24 to the engagement position; and the ice breaker 55 to the unactuated position.

As described above, the door lock device 10 is connected to a door closer 8 via a cable (a tensile member) 7 and holds a door 1 of the vehicle in a fully closed or half closed position (a closed state) while allowing the door 1 to be opened. The door lock device 10 includes a latch housing 11, a latch 21, a pole 22, a closing member 51, an ice breaker 55, and a cancel lever 52. The latch 21 is rotatably supported by the latch housing 11 and is movable to a full latch position where the door 1 is held in a fully closed position, a half latch position where the door 1 is held in a half closed position and prevented from moving to an open position, and an unlatch position where the door 1 is allowed to open. The pole 22 is disposed in the latch housing 11 and is movable between a regulating position where the pole 22 engages the latch 21 and holds the latch 21 in the full latch position and a non-regulating position where the latch 21 is allowed to move from the full latch position toward the unlatch position side. The closing member 51 is rotatably supported by the latch housing 11 and is connected to the cable 7, and causes the latch 21 to move from the half latch position to the full latch position when the latch 21 is in the half latch position and the cable 7 is pulled by the door closer 8. The ice breaker 55 is movable between an unactuated position where the ice breaker 55 is stationary relative to the latch housing 11 and allows rotation of the closing member 51 and an actuated position where the ice breaker 55 engages the closing member 51. When the ice breaker 55 is in the actuated position and the cable 7 is pulled by the door closer 8, the ice breaker 55 moves together with the closing member 51 and presses the latch 21 to move it from the full latch position to the unlatch position side. The cancel lever 52 is movable between a retraction permitting position and a retraction cancel position. The cancel lever 52, when in the retraction permitting position, holds the ice breaker 55 in the unactuated position, and, when the cancel lever 52 moves from the retraction permitting position to the retraction cancel position, moves the ice breaker 55 from the unactuated position to the actuated position.

In this way, when the door 1 of the vehicle is frozen with the latch 21 in the full latch position, by moving the cancel lever 52 from the retraction permitting position to the retraction cancel position and by pulling the cable 7 by the door closer 8, the ice breaker 55 can press the latch 21 to break the ice so that door 1 can be opened. Since the ice breaker 55 is a single component that works in conjunction with the closing member 51 and the cancel lever 52, an increase in the number of parts associated with the addition of the ice breaking function can be suppressed with the door lock device 10. Furthermore, when the cancel lever 52 is held in the retraction permitting position, the ice breaker 55 is held in the unactuated position and stationary relative to the latch housing 11, allowing rotation of the closing member 51. Thus, when the cable 7 is pulled by the door closer 8, the latch 21 can be moved from the half latch position to the full latch position without activating the ice breaker 55, thereby reducing the load on the door closer 8. As a result, the load on the door closer 8 that pulls the cable 7 to move the latch 21 to the full latch position can be reduced, while reducing the number of parts of the door lock device 10 with the ice breaking function and suppressing cost increase.

The door lock device 10 also includes a spring 55s that is supported by the latch housing 11 and biases the ice breaker 55 toward the actuated position, and the closing member 51 and the cancel lever 52 are rotatable around a shaft 5 la provided on the latch housing 11. The closing member 51 includes a guided part 510 protruding parallel to the shaft 5la, and the ice breaker 55 includes a first hole 551 extending in a predetermined direction, a second hole 552, and a third hole 553. In the first hole 551, the shaft 51a is inserted so that the shaft 51 can move freely between one end corresponding to the unactuated position and the other end corresponding to the actuated position. The second hole 552 extends along an arc centered on the shaft 5 la located at the one end of the first hole 551 and also slidably guides the guided part 510 of the closing member 51. The third hole 553 extends from the second hole 552 so as to be separated from the first hole 551 along the predetermined direction (the direction of extension of the first hole 551) and is engageable with the guided part 510 of the closing member 51. When the cancel lever 52 is in the retraction permitting position, the movement of the ice breaker 55 in the predetermined direction is restricted by the biasing force of the spring 55s so that the shaft 5la is located at the one end of the first hole 551. Furthermore, the cancel lever 52 moves from the retraction permitting position to the retraction cancel position, allowing the movement of the ice breaker 55 in the predetermined direction by the biasing force of the spring 55s so that the guided part 510 of the closing member 51 engages the third hole 553.

This allows, when the cancel lever 52 is held in the retraction permitting position, to hold the ice breaker 55 in the unactuated position against the biasing force of the spring 55s, and to rotate the closing member 51 while guiding the guided part 510 along the second hole 552 without activating the ice breaker 55. In addition, by moving the cancel lever 52 from the retraction permitting position to the retraction cancel position, the biasing force of the spring 55s allows the guided part 510 to engage the third hole 553 and move the ice breaker 55 together with the closing member 51.

Further, the door lock device 10 includes a half pole 24 that engages the latch 21 to hold the latch 21 in the half latch position, and the closing member 51 rotatably supports the half pole 24. When the latch 21 is held in the half latch position by the half pole 24 and the cable 7 is pulled by the door closer 8, the closing member 51 presses the half pole 24 to move the latch 21 from the half latch position to the full latch position. The cancel lever 52, when in the retraction permitting position, allows the latch 21 and half pole 24 to engage with each other and slidably guides the half pole 24 that is pressed by the closing member 51. Furthermore, the cancel lever 52, by moving from the retraction permitting position to the retraction cancel position, rotates the half pole 24 relative to the closing member 51 so that the half pole 24 is disengaged from the latch 21. While engagement with the latch 21 is allowed by the cancel lever 52, the half pole 24 engages the ice breaker 55 to hold the ice breaker 55 in the unactuated position against the biasing force of the spring 55s. Also, as the cancel lever 52 moves from the retraction permitting position to the retraction cancel position, the half pole 24 causes the ice breaker 55 to move to the actuated position by allowing the movement of the ice breaker 55 by the biasing force of the spring 55s.

In this way, the half pole 24 has a function as an engagement part to engage the latch 21 and a function to move the ice breaker 55 between the unactuated position and the actuated position, thereby reducing the number of parts and suppressing cost increase of the door lock device 10. Furthermore, when the cancel lever 52 is held in the retraction permitting position, the latch 21 can be moved smoothly from the half latch position to the full latch position while the half pole 24 that is pressed by the closing member 51 is guided slidably by the cancel lever 52. Also, when the cancel lever 52 moves from the retraction permitting position to the retraction cancel position, the cancel lever 52 allows the half pole 24 to rotate relative to the closing member 51 so that the latch 21 is disengaged from the half pole 24, thereby canceling the movement of the latch 21 to the full latch position, that is, the retraction of the door 1, in response to the pulling of the cable 7.

The door lock device 10 also includes a block lever 25 and a block lift lever 26. The block lever 25 is movable between a holding position where the block lever 25 engages the pole 22 and holds the pole 22 in a regulating position and a non-holding position where the block lever 25 allows the pole 22 to move from the regulating position to a non-regulating position. The block lift lever 26 moves from a first position to a second position, by either driving force of the actuator 30 or manual opening operation of the door 1, to move the block lever 25 from the holding position to the non-holding position. The block lift lever 26 also moves from the first position to the third position passing the second position, by either driving force of the actuator 30 or manual opening operation, to move the pole 22 from the regulating position to the non-regulating position. The cancel lever 52 is connected to the block lift lever 26 via a connection member 53 and moves from the retraction permitting position to the retraction cancel position as the block lift lever 26 moves from the first position toward the third position.

In this way, when the block lift lever 26 moves from the first position to the third position by either driving force of the actuator 30 or manual opening operation, the cancel lever 52 moves from the retraction permitting position to the retraction cancel position, and when the block lift lever 26 moves from the first position to the second position, the block lever 25 allows the pole 22 to move from the regulating position to the non-regulating position, then, the pole 22 moves to the non-regulating position. Therefore, moving the block lift lever 26 from the first position to the third position by the actuator 30 or manual opening operation, allows the movement of the latch 21 to the unlatch position, as well as, cancels the movement of the latch 21 to the full latch position in response to the pulling of the cable 7. Then, when the door 1 of the vehicle is frozen with the latch 21 in the full latch position, pressing the latch 21 with the ice breaker 55 with the pole 22 moved to the non-regulating position can break the ice so that the door 1 can be opened.

A door lock device according to the present disclosure is connected to a door closer via a tensile member and holding a door of a vehicle in a closed state while allowing the door to be opened, and includes: a housing; a latch being rotatably supported by the housing and movable to a full latch position where the door is held in a fully closed position, a half latch position where the door is held in a half closed position and prevented from moving to an open position, and an unlatch position where the door is allowed to open; a pole being disposed in the housing and movable between a regulating position where the pole engages the latch and holds the latch in the full latch position and a non-regulating position where the latch is allowed to move from the full latch position to the unlatch position side; a closing member being rotatably supported by the housing and connected to the tensile member, and moving the latch, when the latch is in the half latch position and the tensile member is pulled by the door closer, from the half latch position to the full latch position; an ice breaker being movable between an unactuated position where the ice breaker is stationary relative to the housing and allows rotation of the closing member and an actuated position where the ice breaker engages the closing member, moving, when the ice breaker is in the actuated position and the tensile member is pulled by the door closer, together with the closing member, and pressing the latch in such a way as to move the latch from the full latch position to the unlatch position side; and a cancel member being movable between a retraction permitting position and a retraction cancel position, holding the ice breaker, when in the retraction permitting position, in the unactuated position, moving from the retraction permitting position to the retraction cancel position, and moving the ice breaker from the unactuated position to the actuated position.

The door lock device according to the present disclosure is connected to the door closer via the tensile member and holds the door of the vehicle in a closed state while allowing the door to be opened, and includes a latch, a pole, a closing member, an ice breaker, and a cancel member. When the latch is in a half latch position and the tensile member is pulled by the door closer, the closing member moves the latch from the half latch position to the full latch position. The ice breaker is movable between an unactuated position where the ice breaker is stationary relative to the housing and allows rotation of the closing member and an actuated position where the ice breaker engages the closing member. When the ice breaker is in the actuated position and the tensile member is pulled by the door closer, the ice breaker moves together with the closing member and presses the latch in such a way as to move the latch from the full latch position to the unlatch position side. Furthermore, the cancel member holds, when in the retraction permitting position, the ice breaker in the unactuated position, moves from the retraction permitting position to the retraction cancel position, and moves the ice breaker from the unactuated position to the actuated position. In this way, when the door of the vehicle is frozen with the latch being in the full latch position, by moving the cancel member from the retraction permitting position to the retraction cancel position and by pulling the tensile member by the door closer, the ice breaker can press the latch and break the ice in such a way that the door can be opened. Since the ice breaker is a single component that works in conjunction with the closing member and the cancel member, an increase in the number of parts associated with addition of the ice breaking function can be suppressed with the door lock device according to the present disclosure. Furthermore, when the cancel member is held in the retraction permitting position, the ice breaker is held in the unactuated position and stationary relative to the housing, thereby allowing rotation of the closing member. Thus, when the tensile member is pulled by the door closer, the latch can be moved from the half latch position to the full latch position without activating the ice breaker, thereby reducing a load on the door closer. As a result, the load on the door closer that pulls the tensile member and moves the latch to the full latch position can be reduced, while reducing the number of parts of the door lock device with the ice breaking function and suppressing cost increase.

The door lock device described above may include a biasing member being supported by the housing and biasing the ice breaker toward the actuated position. The closing member and the cancel member may be rotatable around a support shaft provided on the housing, the closing member may include a guided part protruding parallel to the support shaft, the ice breaker may include: a first hole extending in a predetermined direction, into which the support shaft is inserted in such a way that the support shaft is movable between one end associated with the unactuated position and another end associated with the actuated position; a second hole extending along an arc centered on the support shaft located at the one end of the first hole and slidably guiding the guided part of the closing member; and a third hole extending from the second hole in such a way as to be separated from the first hole along the predetermined direction and engageable with the guided part of the closing member, and the cancel member may restrict, when in the retraction permitting position, movement of the ice breaker in the predetermined direction being caused by biasing force of the biasing member in such a way that the support shaft is located at the one end of the first hole, and move from the retraction permitting position to the retraction cancel position, and allow movement of the ice breaker in the predetermined direction being caused by biasing force of the biasing member in such a way that the guided part of the closing member engages the third hole.

The door lock device described above may include a half pole being engageable with the latch and holding the latch in the half latch position. The closing member may rotatably support the half pole and presses, when the half pole holds the latch in the half latch position and the tensile member is pulled by the door closer, the half pole in such a way that the latch moves from the half latch position to the full latch position, the cancel member may allow, when in the retraction permitting position, engagement of the latch and the half pole, slidably guide the half pole that is pressed by the closing member, move from the retraction permitting position to the retraction cancel position, and cause the half pole to rotate relative to the closing member in such a way that the latch is disengaged from the half pole, and the half pole may engage, when engagement with the latch is allowed by the cancel member, the ice breaker and holds the ice breaker in the unactuated position against biasing force of the biasing member, and, in response to movement of the cancel member from the retraction permitting position to the retraction cancel position, allow movement of the ice breaker caused by the biasing force of the biasing member and moves the ice breaker to the actuated position.

The door lock device described above may include: a pole holding member being movable between a holding position where the pole holding member engages the pole and holds the pole in the regulating position and a non-holding position where the pole is allowed to move from the regulating position to the non-regulating position; and a drive member being movable from a first position to a second position, by either driving force of an actuator or manual opening operation of the door, moving the pole holding member from the holding position to the non-holding position, and being movable from the first position to a third position passing the second position, by either the driving force of the actuator or the manual opening operation, and moving the pole from the regulating position to the non-regulating position. The cancel member may be connected to the drive member via a connection member, and, in response to movement of the drive member from the first position to the third position by either the driving force of the actuator or the manual opening operation, move from the retraction permitting position to the retraction cancel position.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

The present disclosure can be used in the door lock device manufacturing industry and other industries.

1. A door lock device being connected to a door closer via a tensile member and holding a door of a vehicle in a closed state while allowing the door to be opened, the door lock device comprising:
a housing;
a latch being rotatably supported by the housing and movable to a full latch position where the door is held in a fully closed position, a half latch position where the door is held in a half closed position and prevented from moving to an open position, and an unlatch position where the door is allowed to open;
a pole being disposed in the housing and movable between a regulating position where the pole engages the latch and holds the latch in the full latch position and a non-regulating position where the latch is allowed to move from the full latch position to the unlatch position side;
a closing member being rotatably supported by the housing and connected to the tensile member, and moving, when the latch is in the half latch position and the tensile member is pulled by the door closer, the latch from the half latch position to the full latch position;
an ice breaker being movable between an unactuated position where the ice breaker is stationary relative to the housing and allows rotation of the closing member and an actuated position where the ice breaker engages the closing member, and moving, when the ice breaker is in the actuated position and the tensile member is pulled by the door closer, together with the closing member and pressing the latch in such a way as to move the latch from the full latch position to the unlatch position side; and
a cancel member being movable between a retraction permitting position and a retraction cancel position, holding the ice breaker, when in the retraction permitting position, in the unactuated position, moving from the retraction permitting position to the retraction cancel position, and moving the ice breaker from the unactuated position to the actuated position.

2. The door lock device according to claim 1, further comprising
a biasing member being supported by the housing and biasing the ice breaker toward the actuated position, wherein
the closing member and the cancel member are rotatable around a support shaft provided on the housing,
the closing member includes a guided part protruding parallel to the support shaft,
the ice breaker includes: a first hole extending in a predetermined direction, into which the support shaft is inserted in such a way that the support shaft is movable between one end associated with the unactuated position and another end associated with the actuated position; a second hole extending along an arc centered on the support shaft located at the one end of the first hole and slidably guiding the guided part of the closing member; and a third hole extending from the second hole in such a way as to be separated from the first hole along the predetermined direction and engageable with the guided part of the closing member, and
the cancel member restricts, when in the retraction permitting position, movement of the ice breaker in the predetermined direction being caused by biasing force of the biasing member in such a way that the support shaft is located at the one end of the first hole, and moves from the retraction permitting position to the retraction cancel position, and allows movement of the ice breaker in the predetermined direction being caused by biasing force of the biasing member in such a way that the guided part of the closing member engages the third hole.

3. The door lock device according to claim 2, further comprising
a half pole being engageable with the latch and holding the latch in the half latch position, wherein
the closing member rotatably supports the half pole and presses, when the half pole holds the latch in the half latch position and the tensile member is pulled by the door closer, the half pole in such a way that the latch moves from the half latch position to the full latch position,
the cancel member allows, when in the retraction permitting position, engagement of the latch and the half pole, slidably guides the half pole that is pressed by the closing member, moves from the retraction permitting position to the retraction cancel position, and causes the half pole to rotate relative to the closing member in such a way that the latch is disengaged from the half pole, and
the half pole engages, when engagement with the latch is allowed by the cancel member, the ice breaker and holds the ice breaker in the unactuated position against biasing force of the biasing member, and, in response to movement of the cancel member from the retraction permitting position to the retraction cancel position, allows movement of the ice breaker caused by the biasing force of the biasing member and moves the ice breaker to the actuated position.

4. The door lock device according to claim 1, further comprising:
a pole holding member being movable between a holding position where the pole holding member engages the pole and holds the pole in the regulating position and a non-holding position where the pole is allowed to move from the regulating position to the non-regulating position; and
a drive member being movable from a first position to a second position, by either driving force of an actuator or manual opening operation of the door, moving the pole holding member from the holding position to the non-holding position, and being movable from the first position to a third position passing the second position, by either the driving force of the actuator or the manual opening operation, and moving the pole from the regulating position to the non-regulating position, wherein
the cancel member is connected to the drive member via a connection member, and, in response to movement of the drive member from the first position to the third position by either the driving force of the actuator or the manual opening operation, moves from the retraction permitting position to the retraction cancel position.

5. The door lock device according to claim 2, further comprising:
a pole holding member being movable between a holding position where the pole holding member engages the pole and holds the pole in the regulating position and a non-holding position where the pole is allowed to move from the regulating position to the non-regulating position; and
a drive member being movable from a first position to a second position, by either driving force of an actuator or manual opening operation of the door, moving the pole holding member from the holding position to the non-holding position, and being movable from the first position to a third position passing the second position, by either the driving force of the actuator or the manual opening operation, and moving the pole from the regulating position to the non-regulating position, wherein
the cancel member is connected to the drive member via a connection member, and, in response to movement of the drive member from the first position to the third position by either the driving force of the actuator or the manual opening operation, moves from the retraction permitting position to the retraction cancel position.

6. The door lock device according to claim 3, further comprising:
a pole holding member being movable between a holding position where the pole holding member engages the pole and holds the pole in the regulating position and a non-holding position where the pole is allowed to move from the regulating position to the non-regulating position; and
a drive member being movable from a first position to a second position, by either driving force of an actuator or manual opening operation of the door, moving the pole holding member from the holding position to the non-holding position, and being movable from the first position to a third position passing the second position, by either the driving force of the actuator or the manual opening operation, and moving the pole from the regulating position to the non-regulating position, wherein
the cancel member is connected to the drive member via a connection member, and, in response to movement of the drive member from the first position to the third position by either the driving force of the actuator or the manual opening operation, moves from the retraction permitting position to the retraction cancel position.
